(19) United States
(12) Patent Application Publication
(10) Pub. No.: US 2012/0020866 A1
(43) Pub. Date: Jan. 26, 2012

(54) METHOD OF PROCESSING LIQUID CHLORINE CONTAINING NITROGEN TRICHLORIDE

(75) Inventors: Clive Brereton, Richmond (CA); Sergio Berretta, Vancouver (CA)

(73) Assignee: NORAM INTERNATIONAL LIMITED, Dublin (IE)

(21) Appl. No.: 13/262,200

(22) PCT Filed: Mar. 6, 2010
(86) PCT No.: PCT/IB2010/000468

§ 371 Date: Sep. 29, 2011

(51) Int. Cl. C01B 21/02; B01J 19/00

(52) U.S. Cl. 423/351; 422/129; 422/198

(57) ABSTRACT

A method of processing a stream of liquid chlorine containing nitrogen trichloride from a chloralkali plant. The liquid stream is received into a vaporizer in which it is evaporated 1O1 chlorine gas and nitrogen trichloride gas. The gas stream is processed by destroying the nitrogen trichloride gas, for example in a superheater or a catalytic bed. The processed gas stream is recycled to the chlorine production train of the chloralkali plant. The process avoids the use of organic solvents to decompose the nitrogen trichloride and the creation of a waste stream requiring further handling.

### BACKGROUND OF THE INVENTION

The invention pertains to the processing of a stream of liquid chlorine containing nitrogen trichloride from a chlorine production process, for example a chloralkali production process.

In the industrial production of chlorine, a small amount of by-product nitrogen trichloride (NCl₃) is produced. In a chloralkali production process, the amount formed is proportional to the amount of ammonia present in the salt fed to the process. Nitrogen follows the product chlorine leaving the chloralkali cell house. It is often removed from the product chlorine through an absorption step, for example in a chlorine scrubber, prior to chlorine compression and liquefaction. In the scrubbing step, nitrogen trichloride is absorbed into fresh, clean product chlorine and pushed down the scrubber and into a holding tank, referred to as the nitrogen trichloride decomposer, containing carbon tetrachloride or sometimes chloroform. In the decomposer, the solvent is maintained at a temperature above the boiling point of the chlorine. When the liquid chlorine contacts the warm solvent, it flashes back into the chlorine scrubber while nitrogen trichloride is absorbed by the solvent. Conditions in the decomposer are selected so that nitrogen trichloride slowly and safely decomposes. In time, tars and other impurities build up in the solvent, and the solvent must be periodically replaced, generating a waste stream that must be disposed of.

For reasons of both regulatory constraints and product quality (i.e. to reduce organic content in the final product chlorine), it is desirable to avoid the use of solvents such as carbon tetrachloride and chloroform in the chlorine production train.

A method of disposing of nitrogen trichloride without using carbon tetrachloride or chloroform solvents is described in U.S. Pat. No. 3,568,409, Ferguson et al., in which gas chlorine from the drying tower is contacted with hydrochloric acid upstream of the compression and liquefaction steps. However, the process produces an acidic waste stream that must be disposed of or used elsewhere.

It would be desirable to provide an improved process for disposing of the nitrogen trichloride removed from the chlorine stream without using organic solvents such as carbon tetrachloride or chloroform, and without generating a waste stream.

### SUMMARY OF THE INVENTION

The invention provides a method of processing a stream comprising liquid chlorine containing nitrogen trichloride contaminant from the chlorine production train of a chlorine production process. The liquid stream is vaporized to produce a stream comprising chlorine gas and nitrogen trichloride gas formed by decomposition of the nitrogen trichloride. That gas stream is processed by destroying the nitrogen trichloride gas, without the use of solvents or liquid chemicals, and producing only one stream, comprising chlorine gas with nitrogen gas, which stream is recycled to the chlorine production train.

The invention further provides an apparatus for processing a stream comprising liquid chlorine containing nitrogen trichloride from a chlorine production train. The apparatus includes a chlorine vaporizer having an inlet for the liquid stream and a boiling zone downstream of the inlet. The apparatus has means for destroying nitrogen trichloride gas downstream of the boiling zone, and means for recycling the resulting stream comprising chlorine gas and nitrogen gas from the nitrogen-destroying means to the chlorine production train.

These and other features of the invention will be apparent from the following description and drawings of particular embodiments.

### BRIEF DESCRIPTION OF THE DRAWINGS

FIG. 1 is a schematic diagram of a first embodiment of the process of the invention, in which nitrogen trichloride is destroyed using a catalytic bed.

FIG. 2 is a schematic diagram of a second embodiment of the process, in which nitrogen trichloride is destroyed using a superheater.

### DETAILED DESCRIPTION OF THE INVENTION

In the following description and in the drawings, corresponding and like elements are referred to by the same reference characters.

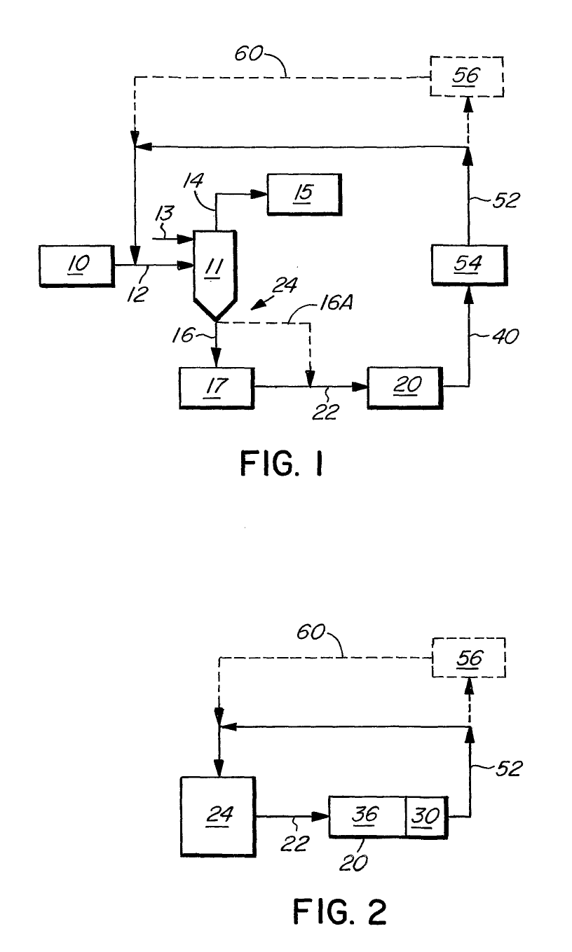

As illustrated in FIG. 1, a chlorine vaporizer 20 receives a stream of liquid chlorine containing nitrogen trichloride (stream 22) from the chlorine production train 24 of a chloralkali plant. The chlorine production train 24 includes a chloralkali cell house 10 in which chlorine gas is produced by the electrolysis of brine. A chlorine scrubber 11 receives a stream 12 of gas chlorine from the cell house and a liquid chlorine stream 13. Other unit operations usually present between the chloralkali cell house 10 and the chlorine scrubber 11 are not shown in the drawings. A gas chlorine stream 14 from the scrubber is fed to a compressor 15 and is thereafter liquefied. From the bottom of the chlorine scrubber 11, liquid chlorine, rich in nitrogen trichloride (stream 16), is fed to a holding tank 17, from which a stream 22 is routed to the vaporizer 20. Alternatively, the liquid chlorine rich in nitrogen trichloride, may be fed directly from the scrubber 11 to the vaporizer 20 (stream 16A) without using any holding tank. The stream 22 typically has 50 ppm or more of nitrogen trichloride, or more than 200 ppm.

The vaporizer 20 produces a stream 40 comprising chlorine gas with nitrogen trichloride gas. This stream is routed to one or more unit operations for the destruction of nitrogen trichloride. The gas leaving the nitrogen trichloride destruction step, i.e. chlorine gas and nitrogen gas, is recycled back to the chlorine production train of the chloralkali process. The process avoids the generation of a waste stream or the addition of other chemicals or solvents to deal with the nitrogen trichloride. The step of destroying the nitrogen trichloride can be carried out in various ways. As illustrated in the embodiment of FIG. 1, the gas formed in the vaporizer 20 may be routed to a catalytic bed 54 in which the nitrogen trichloride is destroyed. The catalytic bed may contain, for example, Monel (trademark) as a catalyst to destroy nitrogen trichloride. The catalytic bed may be operated at temperatures in the range of minus 40 to 300° C., pressures in the range of 0.5 to 100 bar, and a residence time in the range of 0.1 seconds to 5 minutes.

The gas stream 52 leaving the catalytic bed, comprising chlorine gas and nitrogen gas, is recycled back to the chlorine production train 24.

As an alternative to using a catalytic bed, the gas mixture evaporated in the vaporizer may be introduced into a superheater, which may be part of or separate from the vaporizer unit. In the embodiment of FIG. 2, the vaporizer 20 includes a superheater zone 30 downstream of a boiling zone 36. The operating conditions in the superheater are selected so as to achieve substantially complete destruction of nitrogen trichloride. The average operating temperature of the superheater may be in the range of 30° to 300° C., the operating pressure in the range of 0.5 to 100 bar, and the residence time in the range of 0.5 seconds to 5 minutes. Alternatively, the average operating temperature may be in the range of 35° to 250° C., the operating pressure in the range of atmospheric pressure to 90 bar, and the residence time in the range of 1 second to 3 minutes.

The gas stream 52 leaving the superheater, comprising chlorine gas and nitrogen gas, is recycled back to the chlorine production train 24 of the chloralkali process.

Optionally, the process may use both a superheater and a catalytic bed to destroy the nitrogen trichloride. The catalytic bed may be within a superheater zone of the vaporizer, rather than being a separate unit.

Optionally, the gas leaving the nitrogen trichloride destruction step, e.g. the superheater 30 or catalytic bed 54, may be routed to a temperature conditioning step 56 before being recycled back to the chlorine production train (stream 60), as shown in FIGS. 1 and 2. This reduces the temperature of the gas stream leaving the nitrogen trichloride destruction step, which may be at a temperature of about 80° to 120° C., to a lower temperature for introduction into the chlorine train, which may be at a temperature of about minus 35° C.

Although the invention has been described in terms of various embodiments, it is not intended that the invention be limited to these embodiments. Various modifications within the scope of the invention will be apparent to those skilled in the art. The scope of the invention is defined by the claims that follow.

1. A method of processing a stream comprising liquid chlorine containing nitrogen trichloride, comprising the steps of:
(a) receiving the stream comprising liquid chlorine containing nitrogen trichloride from a chlorine production train of a chlorine production process;
(b) vaporizing the liquid stream of step (a) to produce a stream comprising chlorine gas and nitrogen trichloride gas;
(c) processing the stream produced by step (b) by destroying the nitrogen trichloride gas therein, producing a stream comprising chlorine gas and nitrogen gas; and
(d) recycling the stream produced by step (c) to the chlorine production train.

2. A method according to claim 1, wherein the chlorine production train comprises the steps of producing a chlorine gas stream and scrubbing the chlorine gas stream.

3. A method according to claim 2, wherein the chlorine production train further comprises the steps of compressing and liquefying the chlorine gas stream.

4. A method according to claim 2, wherein the recycling of step (d) comprises recycling the stream produced in step (c) to the chlorine gas stream of the chlorine production train.

5. A method according to claim 2, wherein the liquid stream received in step (a) is produced in the scrubbing step.

6. A method according to claim 5, wherein the liquid stream received in step (a) has a concentration of nitrogen trichloride greater than the concentration of nitrogen trichloride in the chlorine gas stream of the chlorine production train.

7. A method according to claim 1, wherein the chlorine production process comprises a chloralkali process.

8. A method according to claim 1, wherein step (c) comprises heating the stream of step (b) to a temperature in the range of 30 to 300 degrees C. at a pressure in the range of 0.5 to 100 bar for a residence time in the range of 0.5 seconds to 5 minutes.

9. A method according to claim 8, wherein the temperature is in the range of 35 to 250 degrees C. and the residence time is in the range of 1 second to 3 minutes.

10. A method according to claim 1, wherein step (c) is done in a superheater.

11. A method according to claim 1, wherein step (c) comprises introducing the stream of step (b) into a catalytic bed containing a nitrogen trichloride-destroying catalyst.

12. A method according to claim 11, wherein the catalytic bed operates at a temperature in the range of minus 40 degrees to 300 degrees C. and a pressure in the range of 0.5 to 100 bar for a residence time in the range of 0.1 second to 5 minutes.

13. A method according to claim 1, further comprising, after step (c), conditioning the temperature of the stream of step (c).

14. A method according to claim 1, wherein the stream of step (a) has a concentration of nitrogen trichloride greater than 50 ppm.

15. A method according to claim 1, wherein the stream of step (a) has a concentration of nitrogen trichloride greater than 200 ppm.

16. A method according to claim 1, in which the method is free of any waste stream production and any addition of nitrogen-trichloride treatment chemicals.

17. An apparatus for processing a stream comprising liquid chlorine containing nitrogen trichloride, comprising:
(a) a chlorine vaporizer;
(b) an inlet for receiving the stream comprising liquid chlorine containing nitrogen trichloride into the vaporizer from a chlorine production train of a chlorine production process;
(c) a boiling zone in the vaporizer downstream of the inlet;
(d) means for destroying nitrogen trichloride gas downstream of the boiling zone; and
(e) means for recycling a stream comprising chlorine gas and nitrogen gas from the nitrogen trichloride-destroying means to the chlorine production train.

18. An apparatus according to claim 17, wherein the chlorine production train comprises a chlorine gas stream and a scrubber for scrubbing the chlorine gas stream.

19. An apparatus according to claim 17, wherein the chlorine production train further comprises a compressor to compress the chlorine gas stream.

20. An apparatus according to claim 18, wherein the means for recycling comprises means for recycling the stream comprising chlorine gas and nitrogen gas from the nitrogen trichloride-destroying means to the chlorine gas stream of the chlorine production train.

21. An apparatus according to claim 18, wherein the inlet for receiving the stream comprising liquid chlorine containing nitrogen trichloride is operatively connected to the scrubber.

22. An apparatus according to claim 18, wherein the means for recycling comprises a conduit operatively connecting the destroying means to the chlorine gas stream.

23. An apparatus according to claim 17, wherein the destroying means comprises a superheater.

24. An apparatus according to claim 23, wherein the superheater comprises a superheating zone in the vaporizer.

25. An apparatus according to claim 17, wherein the destroying means comprises a catalytic bed.

26. An apparatus according to claim 17, wherein the destroying means comprises both a superheater and a catalytic bed.
